(19) United States
(12) Patent Application Publication
(10) Pub. No.: US 2025/0370144 A1
(43) Pub. Date: Dec. 4, 2025

(54) ENHANCED STATE SPACE REPRESENTATION (SSR) PRECISE POSITIONING ENGINE (PPE)

(71) Applicant: QUALCOMM Incorporated, San Diego, CA (US)

(72) Inventors: Min WANG, Tustin, CA (US); Kannan MUTHURAMAN, Mission Viejo, CA (US)

(21) Appl. No.: 18/676,377

(22) Filed: May 28, 2024

(51) Int. Cl. G01S 19/44; G01S 19/07

(52) U.S. Cl. CPC G01S 19/44; G01S 19/072

(57) ABSTRACT

An example method for Global Navigation Satellite System (GNSS)-based positioning performed by a GNSS device, the method may include receiving, from at least one satellite, a plurality of signals across a series of consecutive epochs and determining delta-ionosphere errors for the series of consecutive epochs, wherein each delta-ionosphere error indicates a change in ionospheric delay in carrier phase measurements taken on at consecutive epochs. The method may also include determining an ionosphere delay correction based on accumulating the delta-ionosphere errors and obtaining a position of the GNSS device based on the determined ionosphere delay correction.

### TECHNICAL FIELD

The present disclosure relates generally to the field of satellite-based positioning and more specifically relates to Global Navigation Satellite System (GNSS)-based positioning with improved ionospheric delay correction.

### BACKGROUND

GNSS positioning of mobile devices (e.g., consumer electronics, vehicles, assets, drones, etc.) can provide accurate positioning of a mobile device comprising a GNSS receiver. Traditional GNSS positioning provides an accuracy on the order of a few meters, and more precise GNSS-based techniques can provide sub-meter accuracy. Precise Positioning Engine (PPE) is a GNSS-based positioning technique that provides more precision. The technique uses additional correction information and carrier phase measurement to achieve higher precision than traditional GNSS positioning.

### BRIEF SUMMARY

An example method for Global Navigation Satellite System (GNSS)-based positioning performed by a GNSS device, the method may include receiving, from at least one satellite, a plurality of signals across a series of consecutive epochs and determining delta-ionosphere errors for the series of consecutive epochs, wherein each delta-ionosphere error indicates a change in ionospheric delay in carrier phase measurements taken on at consecutive epochs. The method may also include determining an ionosphere delay correction based on accumulating the delta-ionosphere errors and obtaining a position of the GNSS device based on the determined ionosphere delay correction.

An example Global Navigation Satellite System (GNSS) device for GNSS-based positioning may comprise one or more transceivers, one or more memories, and one or more processors communicatively coupled with the one or more transceivers and the one or more memories. The one or more processors may be configured to receive, from at least one satellite, a plurality of signals across a series of consecutive epochs and determine delta-ionosphere errors for the series of consecutive epochs, wherein each delta-ionosphere error indicates a change in ionospheric delay in carrier phase measurements taken on at consecutive epochs. The one or more processors may also be configured to determine an ionosphere delay correction based on accumulating the delta-ionosphere errors and obtain a position of the GNSS device based on the determined ionosphere delay correction.

An example apparatus for Global Navigation Satellite System (GNSS)-based positioning, the method may include means for determining delta-ionosphere errors for the series of consecutive epochs, wherein each delta-ionosphere error indicates a change in ionospheric delay in carrier phase measurements taken on at consecutive epochs and means for means for determining delta-ionosphere errors for the series of consecutive epochs, wherein each delta-ionosphere error indicates a change in ionospheric delay in carrier phase measurements taken on at consecutive epochs. The apparatus may also include means for means for determining an ionosphere delay correction based on accumulating the delta-ionosphere errors and means for obtaining a position of the apparatus based on the determined ionosphere delay correction.

This summary is neither intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

FIG. 1 is a simplified diagram of a Global Navigation Satellite System (GNSS), according to an embodiment.

FIG. 2 is a block diagram of a Precise Point Positioning (PPP) Precise Positioning Engine (PPE), according to an embodiment.

FIG. 3 is a block diagram illustrating an example Real Time Kinematic (RTK) positioning scheme, according to aspects of the disclosure.

FIG. 4 is an illustration of a table showing the various data fields of state space representation (SSR) data, according to some embodiments.

FIG. 5 is a diagram 500 illustrating a way in which the ionospheric delay correction may be determined, according to an embodiment.

FIG. 6 is a flow diagram illustrating an example method 600 for GNSS-based positioning with improved ionospheric delay correction determination, according to aspects of the disclosure.

FIG. 7 is a block diagram of an embodiment of a GNSS device.

Like reference symbols in the various drawings indicate like elements, in accordance with certain example implementations. In addition, multiple instances of an element may be indicated by following a first number for the element with a letter or a hyphen and a second number. For example, multiple instances of an element 110 may be indicated as 110-1, 110-2, 110-3, etc. or as 110a, 110b, 110c, etc. When referring to such an element using only the first number, any instance of the element is to be understood (e.g., element 110 in the previous example would refer to elements 110-1, 110-2, and 110-3 or to elements 110a, 110b, and 110c).

### DETAILED DESCRIPTION

Several illustrative examples concerning the accompanying drawings will now be described, which form a part hereof. While particular examples in which one or more aspects of the disclosure may be implemented are described below, other examples may be used, and various modifications may be made without departing from the scope of the disclosure.

Reference throughout this specification to “one example” or “an example” means that a particular feature, structure, or characteristic described in connection with the example is included in at least one example of claimed subject matter. Thus, the appearances of the phrase “in one example” or “an example” in various places throughout this specification do not necessarily refer to the same example. Furthermore, the particular features, structures, or characteristics may be combined in one or more examples.

The methodologies described herein may be implemented by various means depending upon applications according to particular examples. For example, such methodologies may be implemented in hardware, firmware, software, and/or combinations thereof. In a hardware implementation, for example, a processing unit may be implemented within one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other devices units designed to perform the functions described herein, and/or combinations thereof.

As used herein, the terms “mobile device” and “User Equipment” (UE) may be used interchangeably and are not intended to be specific or otherwise limited to any particular Radio Access Technology (RAT) unless otherwise noted. In general, a mobile device and/or UE may be any wireless communication device (e.g., a mobile phone, router, tablet computer, laptop computer, tracking device, wearable (e.g., smartwatch, glasses, Augmented Reality (AR)/Virtual Reality (VR) headset, etc.), vehicle (e.g., automobile, vessel, aircraft motorcycle, bicycle, etc.), Internet of Things (IoT) device, etc.), or another electronic device that may be used for Global Navigation Satellite Systems (GNSS) positioning as described herein. According to some embodiments, a mobile device and/or UE may be used to communicate over a wireless communications network. A UE may be mobile or may (e.g., at certain times) be stationary and may communicate with a Radio Access Network (RAN). As used herein, the term UE may be referred to interchangeably as an Access Terminal (AT), a client device, a wireless device, a subscriber device, a subscriber terminal, a subscriber station, a user terminal (UT), a mobile device, a mobile terminal, a mobile station, or variations thereof. Generally, UEs can communicate with a core network via a RAN, and through the core network, the UEs can be connected with external networks (such as the Internet) and with other UEs. Other mechanisms of connecting to the core network and/or the Internet are also possible for the UEs, such as over wired access networks, wireless local area network (WLAN) networks (e.g., based on the Institute of Electrical and Electronics Engineers (IEEE) 802.11 standard, etc.), and so on.

A “space vehicle” (SV), as referred to herein, relates to an object that is capable of transmitting signals to receivers on the Earth's surface. In one particular example, such an SV may comprise a geostationary satellite. Alternatively, an SV may comprise a satellite traveling in an orbit and moving relative to a stationary position on the Earth. However, these are merely examples of SVs and the claimed subject matter is not limited in these respects. SVs also may be referred to herein simply as “satellites.”

As used herein, a dual-band or multi-band satellite refers to a satellite capable of transmitting radio frequency (RF) signals on more than one band or carrier frequency. A single-band satellite refers to a satellite that is transmitting RF signals based on only one band or carrier frequency.

As described herein, a GNSS receiver may comprise and/or be incorporated into an electronic device. This may include a single entity or may include multiple entities, such as in a personal area network where a user may employ audio, video, and/or data I/O devices and/or body sensors and a separate wireline or wireless modem. As described herein, an estimate of the location of a GNSS receiver may be referred to as a location, location estimate, location fix, fix, position, position estimate, or position fix and may be geodetic, thus providing location coordinates for the GPS receiver (e.g., latitude and longitude) which may or may not include an altitude component (e.g., height above sea level, height above or depth below ground level, floor level or basement level). In some embodiments, a location of the GPS receiver and/or an electronic device comprising the GPS receiver may also be expressed as an area or volume (defined either geodetically or in civic form) within which the GPS receiver is expected to be located with some probability or confidence level (e.g., 67%, 95%, etc.). In the description contained herein, the use of the term location may comprise any of these variants unless indicated otherwise. When computing the location of a GPS receiver, such computations may solve for local X, Y, and possibly Z coordinates and then, if needed, convert the coordinates from one coordinate frame to another.

As previously noted, GNSS-based positioning techniques, such as Precise Point Positioning (PPP), can achieve high precision-sometimes to centimeter-level accuracy. To enable this high-precision positioning in a target GNSS device, these techniques apply error correction to measurements performed at the device. State space representation (SSR), which transmits element values of error correction, is one format in which such error correction may be communicated. When SSR data are applied to correct GNSS measurements, they offer the advantages of low bandwidth requirements for the transmission of correction data and global coverage. This contrasts with the use of Observation Space Representation (OSR) data for correction, traditionally utilized in Real-Time kinematics (RTK), which relies on a “lump sum” of error components from a local reference base station. However, the application of SSR data can also present challenges, such as the need for complex error modeling computations and longer convergence times.

When individually handling the error correction elements, of particular interest are error correction for ionospheric delay “iono,” and tropospheric delay, or “tropo,” which, when corrected, can provide significant improvements in accuracy. There are few existing strategies for ionospheric delay handling. One method is the ionosphere-free measurement combination, but it has limitations. For instance, the ionosphere-free measurement combination method requires dual-band or multi-band measurements, such as those from signals transmitted by dual-band or multi-band satellites (e.g., satellites transmitting signals on more than one frequency band/carrier frequency), making it inapplicable to signals from single-band satellites (e.g., satellites transmitting signals on one frequency band/carrier frequency). Another limitation of the ionosphere-free combination method is that the pseudo-range noise and multipath level will be amplified by forming the ionosphere-free linear combinations, which can diminish the benefit of canceling the ionosphere error. Another method for handling ionospheric delay is the ionosphere estimation method, in which the ionosphere delay for each Satellite Vehicle (SV) is estimated in an Extended Kalman Filter (EKF). This causes a large EKF state size, necessitating high memory and throughput. Additionally, the ionosphere estimation method also suffers from longer convergence times due to reduced redundancy for EKF estimation.

Various aspects relate generally to GNSS-based positioning with improved ionospheric delay correction. Some aspects more specifically relate to using SSR data and PPE for positioning a GNSS device with improved ionospheric delay correction. In some examples, the GNSS device may receive a plurality of signals across a series of consecutive epochs from at least one satellite (e.g., including a single-band satellite and/or a dual-band or multi-band satellite). Delta-ionosphere errors for the series of consecutive epochs may be determined, where each delta-ionosphere error indicates a change in ionospheric delay in carrier phase measurements taken at consecutive epochs. An ionospheric delay correction may be determined based on accumulating the delta-ionosphere errors. Based on the determined ionospheric delay correction, the accuracy of the GNSS device's positioning may thereby be improved.

By determining the ionospheric delay correction in this manner, embodiments can achieve better Horizontal Error and shorter convergence time than conventional SSR PPE methods. Additionally, the embodiments provide a unique carrier phase (CP) ionosphere error handling approach that requires limited or even no external ionospheric data but computes corrections internally, enabling the use of less expensive devices without the need for paid correction services (will be discussed in detail below). Furthermore, the embodiments are capable of computing the consecutive delta-ionosphere errors using consecutive carrier phase measurements, regardless of whether the signals are from dual-band, multi-band, or single-band satellites. By applying such accumulated delta-ionosphere corrections, there is no need to estimate the ionospheric component when using non-combined carrier phase measurements in SSR PPE, simplifying the process and potentially reducing the cost and complexity of the system.

Embodiments for determining improved ionospheric delay correction are provided in detail hereafter, following a review of applicable technology.

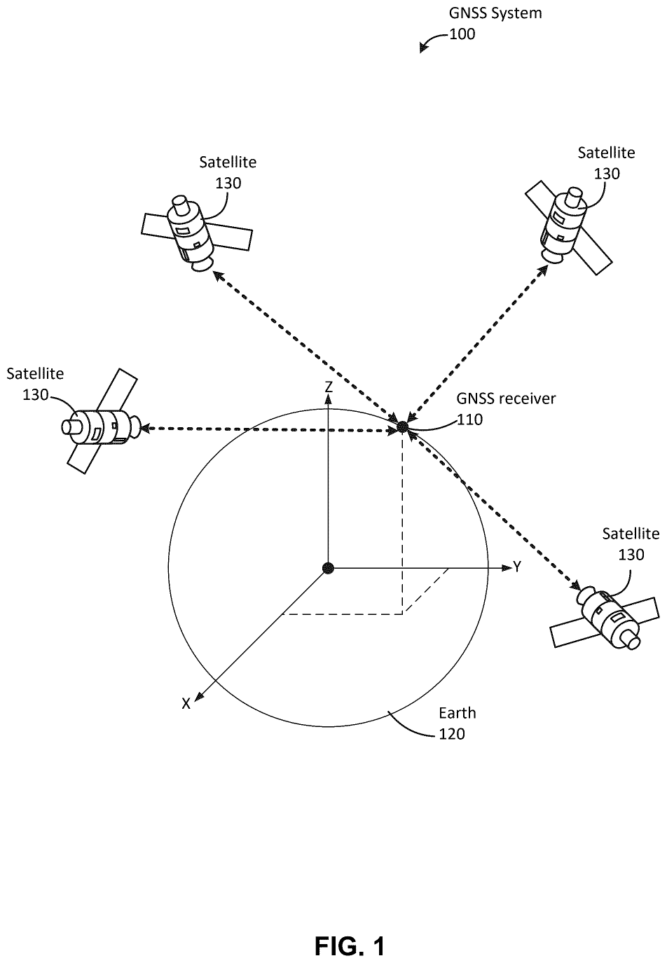

FIG. 1 is a simplified diagram of a GNSS system 100, provided to illustrate how GNSS is generally used to determine an accurate location of a GNSS receiver 110 on Earth 120. Put generally, the GNSS system 100 enables an accurate GNSS position fix of the GNSS receiver 110, which receives RF signals from GNSS satellites 130 (also known as GNSS “satellite vehicles” or “SVs”) from one or more GNSS constellations. The types of GNSS receiver 110 used may vary, depending on the application. In some embodiments, for instance, the GNSS receiver 110 may comprise a standalone device or component incorporated into another device. In some embodiments, the GNSS receiver 110 may be integrated into industrial or commercial equipment, such as survey equipment, Internet of Things (IoT) devices, etc.

It will be understood that the diagram provided in FIG. 1 is greatly simplified. In practice, there may be dozens of satellites 130 and a given GNSS constellation, and there are many different types of GNSS systems. As noted, GNSS systems include GPS, Galileo, GLONASS, or BDS. Additional GNSS systems include, for example, Quasi-Zenith Satellite System (QZSS) over Japan, Indian Regional Navigational Satellite System (IRNSS) over India, etc. In addition to the basic positioning functionality later described, GNSS augmentation (e.g., a Satellite Based Augmentation System (SBAS)) may be used to provide higher accuracy. Such augmentation may be associated with or otherwise enabled for use with one or more global and/or regional navigation satellite systems, such as, e.g., Wide Area Augmentation System (WAAS), European Geostationary Navigation Overlay Service (EGNOS), Multi-functional Satellite Augmentation System (MSAS), and Geo Augmented Navigation system (GAGAN), and/or the like.

GNSS positioning is based on trilateration/multilateration, which is a method of determining position by measuring distances to points at known coordinates. In general, the determination of the position of a GNSS receiver 110 in three dimensions may rely on a determination of the distance between the GNSS receiver 110 and four or more satellites 130. As illustrated, 3D coordinates may be based on a coordinate system (e.g., XYZ coordinates; latitude, longitude, and altitude; etc.) centered at the Earth's center of mass. A distance between each satellite 130 and the GNSS receiver 110 may be determined using precise measurements made by the GNSS receiver 110 of a difference in time from when an RF signal is transmitted from the respective satellite 130 to when it is received at the GNSS receiver 110. To help ensure accuracy, not only does the GNSS receiver 110 need to make an accurate determination of when the respective signal from each satellite 130 is received, but many additional factors need to be considered and accounted for. These factors include, for example, clock differences at the GNSS receiver 110 and satellite 130 (e.g., clock bias), a precise location of each satellite 130 at the time of transmission (e.g., as determined by the broadcast ephemeris), the impact of atmospheric distortion (e.g., ionospheric and tropospheric delays), and the like.

To perform a traditional GNSS position fix, the GNSS receiver 110 can use code-based positioning to determine its distance to each satellite 130 based on a determined delay in a generated pseudorandom binary sequence received in the RF signals received from each satellite, in consideration of the additional factors and error sources previously noted. Code-based positioning measurements for positioning in this manner may be referred to as pseudo-range (or PR) measurements. With the distance and location information of the satellites 130, the GNSS receiver 110 can then determine a position fix for its location. This position fix may be determined, for example, by a Standalone Positioning Engine (SPE) executed by one or more processors of the GNSS receiver 110. However, code-based positioning is relatively inaccurate and, without error correction, is subject to many of the previously described errors. Even so, code-based GNSS positioning can provide a positioning accuracy for the GNSS receiver 110 on the order of meters.

More accurate carrier-based ranging is based on a carrier wave of the RF signals received from each satellite, and error correction is used to help reduce errors from the previously noted error sources. Carrier-based positioning measurements for positioning in this manner may be referred to as carrier phase (or CP) measurements. Some techniques utilize differential error correction, in which errors (e.g., atmospheric error sources) in the carrier-based ranging of satellites 130 observed by the GNSS receiver 110 can be mitigated or canceled based on similar carrier-based ranging of the satellites 130 using a highly accurate GNSS receiver at the base station at a known location. These measurements and the base station's location can be provided to the GNSS receiver 110 for error correction. This position fix may be determined, for example, by a Precise Positioning Engine (PPE) executed by one or more processors of the GNSS receiver 110. More specifically, in addition to the information provided to an SPE, the PPE may use base station GNSS measurement information and additional correction information, such as troposphere and ionosphere, to provide a high-accuracy, carrier-based position fix. Several GNSS techniques can be adopted in PPE, such as Differential GNSS (DGNSS), Real-Time Kinematic (RTK), and Precise Point Positioning (PPP), and may provide a sub-meter accuracy (e.g., on the order of centimeters). (An SPE and/or PPE may be referred to herein as a GNSS positioning engine and may be incorporated into a broader positioning engine that uses other (non-GNSS) positioning sources.)

Multi-frequency GNSS receivers use satellite signals from different GNSS frequency bands (also referred to herein simply as “GNSS bands”) to determine desired information such as pseudoranges, position estimates, and/or time. Using multi-frequency GNSS may provide better performance (e.g., position estimate speed and/or accuracy) than single-frequency GNSS in many conditions. However, using multi-frequency GNSS typically uses more power than single-frequency GNSS, e.g., processing power and battery power (e.g., to power a processor (e.g., for determining measurements), baseband processing, and/or RF processing).

Referring again to FIG. 1, the satellites 130 may be members of a single satellite constellation, i.e., a group of satellites that are part of a GNSS system, e.g., controlled by a common entity such as a government, and orbiting in complementary orbits to facilitate determining positions of entities around the world. One or more of the satellites 130 may transmit multiple satellite signals in different GNSS frequency bands, such as L1, L2, and/or L5 frequency bands. The terms L1 band, L2 band, and L5 band are used herein because these terms are used for GPS to refer to respective ranges of frequencies. Various receiver configurations may be used to receive satellite signals. For example, a receiver may use separate receive chains for different frequency bands. As another example, a receiver may use a common receive chain for multiple frequency bands that are close in frequency, for example, L2 and L5 bands. As another example, a receiver may use separate receive chains for different signals in the same band, for example, GPS L1 and GLONASS L1 sub-bands. A single receiver may use a combination of two or more of these examples. These configurations are examples, and other configurations are possible.

Multiple satellite bands are allocated to satellite usage. These bands include the L-band, used for GNSS satellite communications, the C-band, used for communications satellites such as television broadcast satellites, the X-band, used by the military and for RADAR applications, and the Ku-band (primarily downlink communication and the Ka-band (primarily uplink communications), the Ku and Ka bands used for communications satellites. The L-band is defined by IEEE as the frequency range from 1 to 2 GHz. The L-Band is utilized by the GNSS satellite constellations such as GPS, Galileo, GLONASS, and BDS, and is broken into various bands, including L1, L2, and L5. For location purposes, the L1 band has historically been used by commercial GNSS receivers. However, measuring GNSS signals across more than one band may provide for improved accuracy and availability.

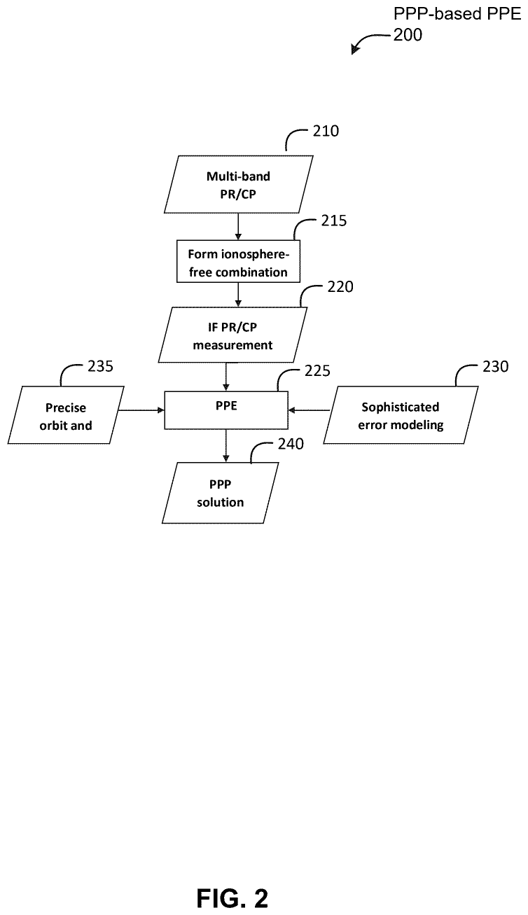

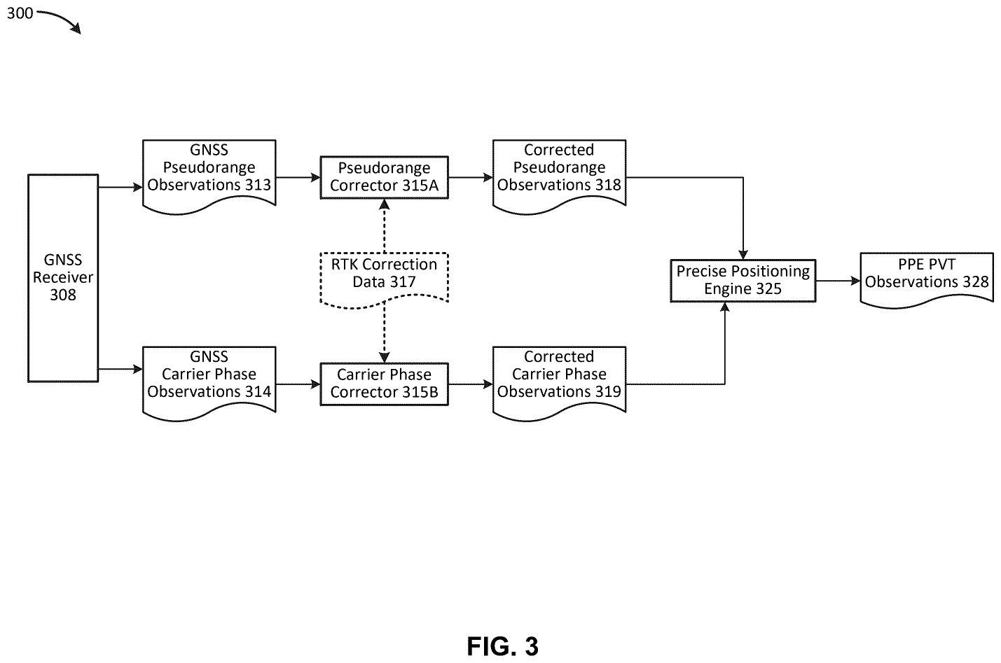

As previously noted, high-accuracy, or “precise,” GNSS-based positioning (e.g., PPP or RTK positioning) utilizes error correction provided by an error correction service. FIGS. 2 and 3 generally illustrate how such correction may be utilized in PPP and RTK.

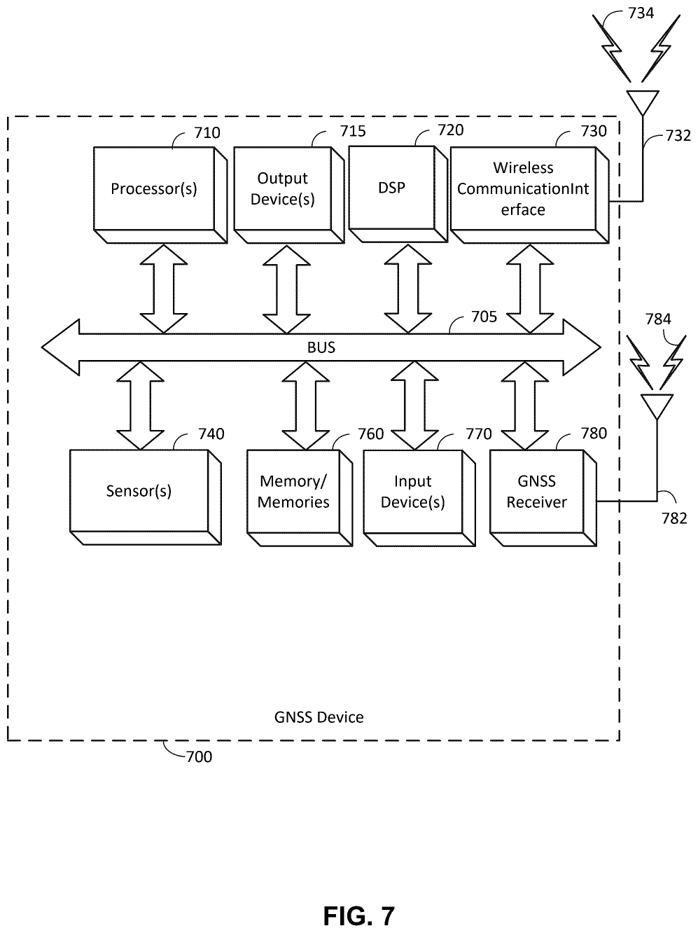

FIG. 2 is a block diagram of a PPP-based PPE 200, which may be used to determine an accurate PPP-based position. The blocks in FIG. 2 comprise data and logical processes used by a PPE to perform PPP-based positioning of a GNSS receiver (e.g., the GNSS receiver 110 of FIG. 1). In some embodiments, the various blocks in FIG. 2 may be implemented by software and/or hardware components of a positioning engine, which may be integrated into the mobile device for which positioning is determined. (Example components of a mobile device are shown in FIG. 7, which is described in detail hereafter.).

At block 210, the GNSS receiver obtains multi-band pseudo-range (PR) and carrier phase (CP) measurement of signals from each of the plurality of satellites (e.g., satellites 130 of FIG. 1). PR and CP measurements may correspond with code-based and carrier-based measurements, respectively, as previously described. To make a multi-band measurement (a measurement of signals using two or more frequencies transmitted by a satellite), embodiments may use a multi-band GNSS receiver (e.g., a dual-band receiver, tri-band receiver, etc.) capable of receiving a plurality of frequency bands. Some embodiments may use multi-constellation multi-frequency (MCMF) receivers capable of receiving multiple frequency bands on multiple constellations. Examples of different bands used for the multi-band PR/CP measurement at block 210 include L1/L5 for GPS, E1/E5A for GAL, and B1C/B2A for BDS. Other embodiments may use additional or alternative bands and/or GPS constellations.

At block 215, an ionosphere-free (IF) combination is formed. An ionosphere-free combination comprises a linear combination of code and/or carrier measurements that can eliminate first-order ionospheric effects from ionospheric refraction, which can increase the accuracy of the positioning solution. As shown by block 220, the ionosphere-free (IF) PR/CP measurement formed from the IF combination is provided to a PPE 225.

The sophisticated error modeling at block 230 comprises error modeling to mitigate inaccuracies based on various error sources. Standard PPP error mitigation includes error reduction techniques to reduce satellite different code bias (DCB), satellite phase windup-up, site displacement, and more. These errors may result in inaccuracies of several meters or more, and mitigation can be performed by a Kalman Filter (KF) (or Extended Kalman Filter (EKF)), which may estimate these errors/values.

The PPE 225 uses the IF PR/CP measurement (block 220), sophisticated error modeling (block 230), and precise orbit and clock (block 235) to conduct a KF estimation to provide the PPP solution at block 240. As a person of ordinary skill in the art will appreciate, a PPE can be implemented using an Extended Kalman Filter (EKF).

FIG. 3 is a block diagram illustrating an example RTK positioning scheme 300, according to aspects of the disclosure. In some embodiments, the various blocks may be implemented by software and/or hardware components of a positioning engine, which may be integrated into the mobile device for which positioning is determined. (Example components of a mobile device are shown in FIG. 7, which is described in detail hereafter.)

According to positioning scheme 300, a GNSS receiver 308 measures GNSS signals to obtain GNSS pseudorange observations 313 and GNSS carrier phase observations 314. In various examples, the GNSS receiver 308 may correspond to GNSS receiver 110 of FIG. 1 and/or may be incorporated into a mobile or other device (e.g., a mobile device as described herein). Based on RTK correction data 317, a pseudorange corrector 315A corrects GNSS pseudorange observations 313 to obtain corrected pseudorange observations 318, and a carrier phase corrector 315B corrects GNSS carrier phase observations 314 to obtain corrected carrier phase observations 319. In various examples, the RTK correction data 317 may be representative of correction data provided by a correction service (e.g., RTK correction service). Based on corrected pseudorange observations 318 and corrected carrier phase observations 319, a precise positioning engine (PPE) 325 generates PPE position, velocity, and time (PVT) observations 328.

High-precision PPE position determination (e.g., using PPP and/or RTK) for a GNSS device typically utilizes error correction received from a remote device (e.g., error correction service). Although PPP products may use state-space representation (SSR) format for error correction, conventionally, most RTK products use error correction in observation-space representation (OSR) format. OSR format provides a “lump sum” of error components that are represented in observation space. These components may include pseudo-range, carrier phase, Doppler, and CN0 from multiple GNSS constellations, signals, and satellites (SVs).

As noted, devices may utilize a PPE for high-precision positioning using PPP and/or RTK correction information. PPP with SSR data and RTK with OSR data each have their benefits and drawbacks. RTK, which uses differential GNSS readings between a rover station and one or more local base stations, offers straightforward error modeling computation and effective error cancelation. However, RTK's drawbacks include the need for local or regional reference stations (e.g., necessitates a high-density base station network) and a larger bandwidth requirement compared to PPP. PPP, which provides precise orbit and clock information to a target device, along with optional ionospheric and tropospheric corrections for enhancement, benefits from lower bandwidth requirements and global coverage. Its drawbacks, however, include complex error modeling computations and the cost for additional correction data, despite SSR1-SSR3 being broadcast for free (will be discussed in detail below). Nonetheless, if every SSR correction component is accessible and sufficiently accurate, it can deliver performance comparable to OSR.

To better commercialize low-cost GNSS devices, an increasing number of modern products are beginning to accept or offer error correction in SSR format. This trend is driven by several advantages of the SSR format, as noted above. These include the use of smaller communication bandwidth (resulting in less traffic), scalable frequency operation (with no frequency dependency), inclusion in many standard evolutions (such as the Radio Technical Commission for Maritime Services (RTCM), the 3rd Generation Partnership Project (3GPP), and the International GNSS Service (IGS)), and the availability of a portion of SSR data (orbit, clock, code bias) to the public, including services like the IGS SSR and BDS (Beidou) B2b (or B2b-PPP) corrections.

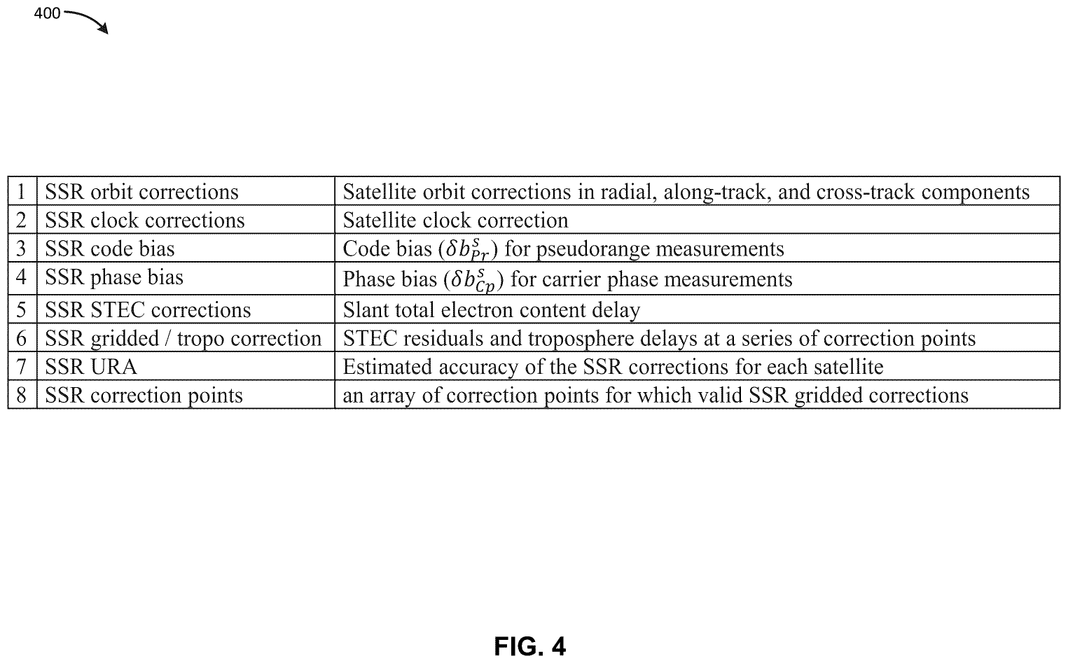

FIG. 4 is an illustration of Table 400, showing the various data fields of SSR data, according to some embodiments. Specifically, SSR data may include eight types of data, which may be referred to herein by “SSR,” followed by the responded numeral in the first column of Table 400. Thus, SSR1 comprises satellite orbit corrections, SSR2 comprises deadline clock corrections, SSR3 comprises code bias (e.g., differential code bias (DCB)), SSR4 comprises phase bias, SSR5 comprises slants total electron content (STEC) delay correction (e.g., ionospheric delay correction), SSR6 (which may be referred to herein generally as tropospheric delay correction) comprises STEC residuals and tropospheric delays, SSR7 comprises an estimated accuracy value (e.g., user range accuracy (URA)) of other SSR data (e.g., SSR1-SSR6), and SSR8 comprises correction points for which valid SSR gridded corrections are applicable. In error correction, SSR may be provided as a vector with one or more of the data fields shown in Table 400, where each element of the vector represents a different data field.

Generally put, the more SSR elements that are used for positioning, the more accurate the positioning solution can be. For example, SSR1-SSR3 may be considered “standard” SSR for PPP solutions. Although this can result in increasing GNSS-based positioning accuracy from 5-10 m to roughly 2.5-5 m, the accuracy is case-dependent (e.g., based on conditions like current ionosphere error), and convergence time may be relatively long if only SSR1-SSR3 are used. The standard SSR elements (SSR1-SSR3) are broadcast to the public for free, allowing for free increased accuracy over traditional GNSS positioning. But, many applications require higher accuracy and/or lower convergence times, in which case additional SSR elements are needed. According to traditional techniques, SSR data are obtained using a network of reference GNSS receivers distributed geographically over a coverage region. Because SSR1-SSR3 require relatively fewer receivers than SSR5-SSR6, this data may be obtained at a relatively low cost. However, according to these traditional techniques, obtaining SSR5-SSR6 using a relatively dense network of references GNSS receivers can be costly.

As stated above, error correction for the ionospheric delay, or “iono,” (SSR5) and tropospheric delay, or “tropo,” (SSR6) are of particular interest, which, when corrected, can provide significant improvements in accuracy. Besides obtaining ionospheric delay data at cost, the existing strategies for ionospheric delay handling, including the ionosphere-free measurement combination and ionosphere estimation method, have drawbacks. For instance, the ionosphere-free measurement combination method requires dual-band or multi-band measurements, making it inapplicable to signals from single-band satellites. Another limitation of the ionosphere-free combination is that the pseudo-range noise and multipath level will be amplified by forming the ionosphere-free linear combinations, which can diminish the benefit of canceling the ionosphere error. The ionospheric estimation method, in which the ionosphere delay for each SV is estimated in an EKF, suffers from a large EKF state size, necessitating high memory and throughput. Additionally, ionosphere estimation also suffers from longer convergence times due to reduced redundancy for EKF estimation.

Embodiments herein provide a solution for determining ionospheric delay correction with limited SSR data availability (e.g., limited or no SSR5 data available). Specifically, the ionospheric delay correction may be determined based on signals from satellite(s) across a series of consecutive epochs. In some embodiments, the ionospheric delay correction may be determined by accumulating the delta-ionosphere errors for the series of consecutive epochs. Each of the delta-ionosphere errors indicates a change in ionospheric delay in measurements taken at consecutive epochs. This provides a unique carrier phase ionosphere error handling approach that requires limited or even no external ionospheric data but computes corrections internally. This enables the use of less expensive devices by simplifying the process, reducing the complexity of the system, and eliminating the need for paid correction services. The converge time for determining the ionospheric delay correction may also be reduced.

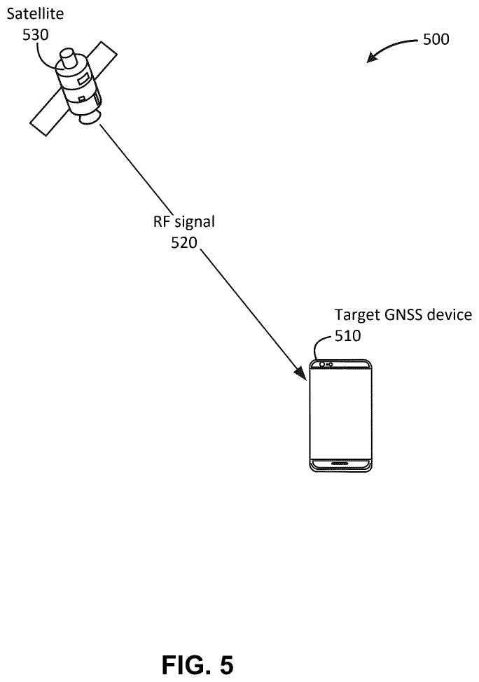

FIG. 5 is a diagram 500 illustrating a way in which the ionospheric delay correction may be determined, according to an embodiment. In this example, the target GNSS device 510 may comprise a mobile device, base station, or other device comprising and/or communicatively coupled with a GNSS receiver, as disclosed herein. At least one satellite 530 may comprise single-band satellite(s) and/or dual-band or multi-band satellite(s) and may correspond to the satellite 130 in FIG. 1.

As shown in FIG. 5, the target GNSS device 510 may receive from at least one satellite 530, a plurality of signals (e.g., RF signals 520) across a series of consecutive epochs (e.g., t₁, t₂, . . . . T_{N}). The target GNSS device 510 may take carrier phase measurement Φₜ at each of the epoch in the series of consecutive epochs t₁, t₂, . . . . T_{N} and may determine a delta-ionosphere error at consecutive epochs (e.g., tₙ₋₁ and tₙ), indicating a change in ionospheric delay in the measurements taken at the consecutive epochs (e.g., Φₜₙ₋₁ and Φₜₙ). In some embodiments, the target GNSS device 510 may determine an ionospheric delay correction based on accumulating the delta-ionosphere errors. The position of the GNSS device may then be determined based on the ionospheric delay correction and obtained by the target GNSS device 510, using the GNSS-based positioning techniques disclosed above. The position of the target GNSS device 510 may be determined by a server (not shown) or the target GNSS device 510 itself, depending on the configuration.

As will be discussed in detail below, the ionospheric delay correction may be determined differently in situations where the RF signals 520 are received from signal-band satellite(s) (e.g., the at least one satellite 530 includes signal-band satellite(s)) or where the RF signals 520 are received from dual-band or multi-band satellite(s) (e.g., the at least one satellite 530 include dual-band or multi-band satellite(s)).

### Situations Where the at Least One Satellite 530 Includes a Dual-Band or Multi-Band Satellite

In situations where the at least one satellite 530 includes a dual-band or multi-band satellite, the received signals on each epoch may include at least two RF signals on two different bands/carrier frequencies Lᵢ and Lⱼ (e.g., more than one of GNSS frequency bands L1, L2, L5, etc.). For example, at epoch tₙ, two carrier phase measurements Φ_{Li,tn} and Φ_{Lj,tn} on different carrier frequencies Lᵢ and Lⱼ may be taken. As noted above, Φ_{Li,tn} and Φ_{Lj,tn} may include different error components and may be represented by the following equations:

$$\begin{matrix}{ϕ}_{Li , tn} = {ρ}_{tn} + {dT}_{tn} + δ Orb + δ Clk + {ISTB}_{Li} + {dTrop}_{tn} - \frac{{f}_{1}^{2} * {dIono}_{tn}}{{f}_{i}^{2}} \\ + {λ}_{Li} ( {N}_{Li} + {r}_{Li} - {s}_{Li} ) + {ϵ}_{{ϕ}_{Li , tn}}\end{matrix} \qquad ( Eqn . 1 )$$

$$\begin{matrix}{ϕ}_{Lj , tn} = {ρ}_{tn} + {dT}_{tn} + δ Orb + δ Clk + {ISTB}_{Lj} + {dTrop}_{tn} - \frac{{f}_{1}^{2} * {dIono}_{tn}}{{f}_{j}^{2}} \\ + {λ}_{Lj} ( {N}_{Lj} + {r}_{Lj} - {s}_{Lj} ) + {ϵ}_{{ϕ}_{Lj , tn}}\end{matrix} \qquad ( Eqn . 2 )$$

Where ρ is the geometry range in meters, dT is the receiver clock in meters, δOrb is the satellite orbit error in meters, δClk is the satellite clock error in meters, ISTB is the inter/intra system/signal time biases in meters, dTrop is the troposphere delay residual error after applying the model, dIono is the ionospheric delay residual error on the specified signal bands after applying the model, f is the central frequency of the specified signal band in Hz, N is the ambiguity integer term in cycles, r is the ambiguity receiver fractional bias term in cycles, s is the ambiguity satellite fractional bias term in cycles, and ∈ is the noise and multipath in meters.

The geometry-free (e.g., both ionosphere-free and troposphere-free) CP measurement may be calculated as follows:

$$\begin{matrix}{ϕ}_{Li , tn} - {ϕ}_{Lj , tn} = ( {ISTB}_{Li} - {ISTB}_{Lj} ) - ( \frac{{f}_{1}^{2} * {dIono}_{tn}}{{f}_{i}^{2}} - \frac{{f}_{1}^{2} * {dIono}_{tn}}{{f}_{j}^{2}} ) \\ + [ {λ}_{Li} ( {N}_{Li} + {r}_{Li} - {s}_{Li} ) - {λ}_{Lj} ( {N}_{Lj} + {r}_{Lj} - {s}_{Li} ) ]\end{matrix} \qquad ( Eqn . 3 )$$

When calculating the delta-ionosphere error on consecutive epochs tₙ₋₁ and tₙ, parameters such as ISTB, N, r, and s do not change over time and thus can be canceled out in the equation as follows:

$$( {ϕ}_{Li , tn} - {ϕ}_{Lj , tn} ) - ( {ϕ}_{Li , tn - 1} - {ϕ}_{Lj , tn - 1} ) = ( \frac{{f}_{1}^{2} - {f}_{j}^{2}}{{f}_{i}^{2} {f}_{i}^{2}} * {f}_{1}^{2} * {dIono}_{tn} ) + ( \frac{{f}_{1}^{2} - {f}_{j}^{2}}{{f}_{i}^{2} {f}_{i}^{2}} * {f}_{1}^{2} * {dIono}_{tn - 1} ) \qquad ( Eqn . 4 )$$

Therefore, the delta-ionosphere error on consecutive epochs tₙ₋₁ and tₙ may be calculated as follows:

$$( {dIono}_{tn} {ono}_{tn - 1} ) = [ \frac{( {ϕ}_{Li , tn} - {ϕ}_{Lj , tn} ) - ( {ϕ}_{Li , tn - 1} - {ϕ}_{Lj , tn - 1} )}{\frac{{f}_{i}^{2} - {f}_{j}^{2}}{{f}_{i}^{2} {f}_{i}^{2}} * {f}_{1}^{2}} ] \qquad ( Eqn . 5 )$$

The accumulated delta-ionosphere error on the series of consecutive epochs t₁ to t_{N} may then be calculated as follows:

$$( dIono {ono}_{t 0} ) = {\sum }_{i = 1}^{N} ( {dIono}_{t ι} {ono}_{t ι - 1} ) \qquad ( Eqn . 6 )$$

In some embodiments, the accumulated delta-ionosphere errors can be used to determine the carrier phase ionospheric delay correction accordingly. For example, the accumulated delta-ionosphere errors may be applied in SSR PPE positioning, and thus, there is no need to estimate any ionospheric error component in the EKF.

### Situations Where the at Least One Satellite 530 Includes a Single-Band Satellite

Additionally or alternatively, in situations where the at least one satellite 530 includes a single-band satellite, the received signals on each epoch may include RF signals on only one band/carrier frequency Lᵢ (e.g., one of GNSS frequency bands L1, L2, L5, etc.). For example, at epoch tₙ, a carrier phase measurement Φ_{Li,tn} on carrier frequency Lᵢ may be taken. As noted above, Φ_{Li,tn} may include different error components and may be represented by the following equations:

$$\begin{matrix}{ϕ}_{Li , tn} = {ρ}_{tn} + {dT}_{tn} + δ Orb + δ Clk + {ISTB}_{Li} + {dTrop}_{tn} - \frac{{f}_{1}^{2} * {dIono}_{tn}}{{f}_{i}^{2}} \\ + {λ}_{Li} ( {N}_{Li} + {r}_{Li} - {s}_{Li} ) + {ϵ}_{{ϕ}_{Li , tn}}\end{matrix} \qquad ( Eqn . 7 )$$

Where ρ is the geometry range in meters, dT is the receiver clock in meters, δOrb is the satellite orbit error in meters, δClk is the satellite clock error in meters, ISTB is the inter/intra system/signal time biases in meters, dTrop is the troposphere delay residual error after applying the model, dIono is the ionospheric delay residual error on the specified signal band (e.g., Lᵢ) after applying the model, f is the central frequency of the specified signal band in Hz, N is the ambiguity integer term in cycles, r is the ambiguity receiver fractional bias term in cycles, s is the ambiguity satellite fractional bias term in cycles, ∈ is the noise and multipath in meters.

When calculating the delta-ionosphere error on consecutive epochs tₙ₋₁ and tₙ, because ISTB, N, r, and s do not change over time, they can be canceled out in the equation. Also, δOrb, δClk, dTrop do not change significantly, and thus, they may be considered the same over the consecutive epochs. Therefore, the difference between the two carrier phase measurements from two consecutive epochs tₙ₋₁ and tₙ can be represented as follows:

$$\begin{matrix}{ϕ}_{Li , tn} - {ϕ}_{Li , tn - 1} = {ρ}_{tn} + {dT}_{tn} - ( {ρ}_{tn - 1} + {dT}_{tn - 1} ) - \frac{{f}_{1}^{2} * ( {dIono}_{tn} - {dIono}_{tn - 1} )}{{f}_{i}^{2}} + {ϵ}_{{ϕ}_{Li , tn}} - {ϵ}_{{ϕ}_{Li , tn - 1}} \\ = δ - \frac{{f}_{1}^{2} * ( {dIono}_{tn} - {dIono}_{tn - 1} )}{{f}_{i}^{2}} + {ϵ}_{{ϕ}_{Li , tn}} - {ϵ}_{{ϕ}_{Li , tn - 1}}\end{matrix} \qquad ( Eqn . 8 )$$

Where a geometry-clock differential δ indicating a difference in combined geometry range and receiver clock offset between the consecutive epochs may be represented as follows:

$$δ = {ρ}_{tn} + {dT}_{tn} - ( {ρ}_{tn - 1} + {dT}_{tn - 1} ) \qquad ( Eqn . 9 )$$

Different from situations where the signals are received from dual-band or multi-band satellite(s), the value of δ may be obtained from another satellite with the ability to transmit signals on more than one band (e.g., dual-band or multi-band satellite(s)). Additionally or alternatively, the value of δ may be obtained from an Inertial Measurement Unit associated with the target GNSS device 510.

Therefore, the delta-ionosphere error on consecutive epochs tₙ₋₁ and tₙ may be calculated based on the geometry-clock differential δ as follows:

$$( {dIono}_{tn} {ono}_{tn - 1} ) = [ \frac{( {ϕ}_{Li , tn} - {ϕ}_{Li , tn - 1} ) - \hat{δ}}{- \frac{{f}_{1}^{2}}{{f}_{i}^{2}}} ] \qquad ( Eqn . 10 )$$

The accumulated delta-ionosphere error on the series of consecutive epochs t₁ to t_{N} may then be calculated as follows:

$$( dIono {ono}_{t 0} ) = {\sum }_{i = 1}^{N} ( {dIono}_{t ι} {ono}_{t ι - 1} ) \qquad ( Eqn . 11 )$$

Similar to situations where the signals are received from dual-band or multi-band satellite(s), in some embodiments, the accumulated delta-ionosphere errors here can also be used to determine the carrier phase ionospheric delay correction accordingly. For example, the accumulated delta-ionosphere errors may be applied in SSR PPE positioning, and thus, there is no need to estimate any ionospheric error component in the EKF.

As stated above, the technical solutions enable the determination of carrier phase ionospheric delay correction with limited SSR data availability (e.g., limited or no SSR5 data available). This facilitates a unique carrier phase ionosphere error handling approach that requires minimal or no external ionospheric data and computes corrections internally. Consequently, it allows for the use of less expensive devices by simplifying the process, thereby reducing the complexity of the system and eliminating the need for paid correction services. The converge time for determining the ionospheric delay correction may also be reduced.

In some embodiments, to further improve the positioning performance, the pseudo-range ionosphere error (e.g., determining a pseudo-range ionospheric delay correction) may also be corrected. For example, the pseudo-range ionosphere error can be corrected using ephemeris model(s). Additionally or alternatively, the pseudo-range ionosphere error may also be corrected using a Satellite-Based Augmentation System (SNAS) ionosphere model.

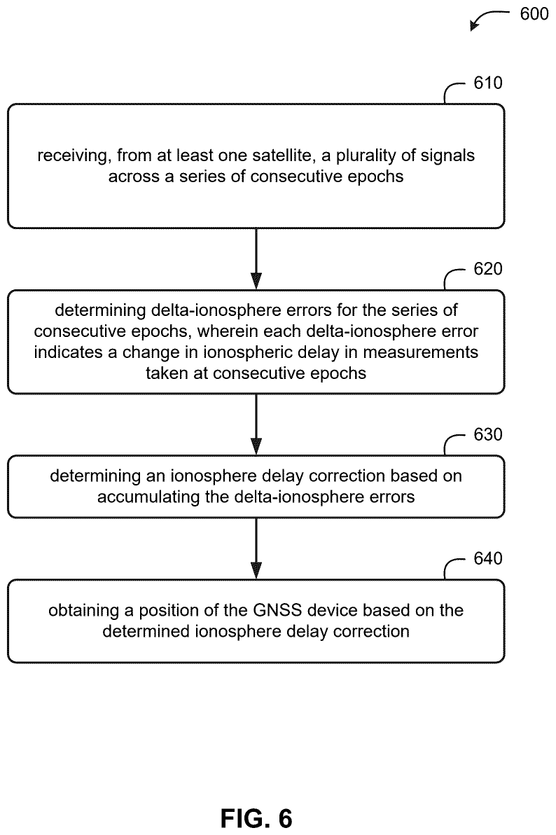

FIG. 6 is a flow diagram illustrating an example method 600 for GNSS-based positioning with improved ionospheric delay correction determination, according to aspects of the disclosure. According to aspects of the disclosure, means for performing the functionality illustrated in one or more of the blocks shown in FIG. 6 may be performed by hardware and/or software components of a GNSS device (which may comprise a mobile device, base station, or other device comprising and/or communicatively coupled with a GNSS receiver). Example components of a GNSS device are illustrated in FIG. 7, which is described in more detail below.

At block 610, the functionality comprises receiving, from at least one satellite, a plurality of signals across a series of consecutive epochs. As noted above, in some embodiments, the at least one satellite may comprise a dual-band or multi-band satellite and the plurality of signals comprise signals transmitted on at least two carrier frequencies. Additionally or alternatively, the at least one satellite may comprise a single-band satellite.

Means for performing functionality at block 610 may comprise a bus 705, processor(s) 710, digital signal processor (DSP) 720, memory/memories 760, GNSS receiver 780, and/or other components of a GNSS device 700, as illustrated in FIG. 7, for example.

At block 620, the functionality comprises determining delta-ionosphere errors for the series of consecutive epochs, wherein each delta-ionosphere error indicates a change in ionospheric delay in carrier phase measurements taken at consecutive epochs.

As noted above, in situations where the at least one satellite includes a dual-band or multi-band satellite, the delta-ionosphere error for a change in ionospheric delay in measurements taken at consecutive epochs may be determined according to Eqn. 1 to Eqn. 5, including determining an ionosphere-free combination of the carrier phase measurements from the signals transmitted on the at least two carrier frequencies.

In situations where the at least one satellite includes a single-band satellite, the delta-ionosphere error for a change in ionospheric delay in measurements taken at consecutive epochs may be determined according to Eqn. 7 to Eqn. 10.

Specifically, a geometry-clock differential δ indicating a difference in combined geometry range and receiver clock offset between the consecutive epochs may be obtained from another satellite with the ability to transmit signals on more than one band (e.g., dual-band or multi-band satellite(s)). Additionally or alternatively, the value of δ may be obtained from an Inertial Measurement Unit associated with the GNSS device.

Means for performing functionality at block 620 may comprise a bus 705, processor(s) 710, digital signal processor (DSP) 720, memory/memories 760, GNSS receiver 780, and/or other components of a GNSS device 700, as illustrated in FIG. 7, for example.

At block 630, the functionality comprises determining an ionosphere delay correction based on accumulating the delta-ionosphere errors.

As noted above, in situations where the at least one satellite includes a dual-band or multi-band satellite, the accumulated delta-ionosphere error may be determined according to Eqn. 6. In situations where the at least one satellite includes a single-band satellite, the accumulated delta-ionosphere error may be determined according to Eqn. 11.

Means for performing functionality at block 630 may comprise a bus 705, processor(s) 710, digital signal processor (DSP) 720, memory/memories 760, GNSS receiver 780, and/or other components of a GNSS device 700, as illustrated in FIG. 7, for example.

At block 640, the functionality comprises obtaining a position of the GNSS device based on the determined ionosphere delay correction. As noted above, in some embodiments, the position of the GNSS device may be determined based on SSR correction data and the determined ionosphere delay correction. In some embodiments, the position of the GNSS device may be determined using PPE. It is understood that the position of the GNSS device may be determined according to any of the suitable GNSS-based positioning schemes disclosed above.

Means for performing functionality at block 640 may comprise a bus 705, processor(s) 710, digital signal processor (DSP) 720, memory/memories 760, GNSS receiver 780, and/or other components of a GNSS device 700, as illustrated in FIG. 7, for example.

In some embodiments, the method 600 may further include determining the position of the GNSS device by further correcting a pseudo-range ionosphere error.

In some embodiments, correcting the pseudo-range ionosphere error may be performed using a Satellite-Based Augmentation System ionosphere model.

FIG. 7 is a block diagram of an embodiment of a GNSS device 700, which can be utilized as described herein above (e.g., in association with FIGS. 1-6). For example, the GNSS device 700 can be used to implement one or incorporate the GNSS receiver 110 of FIG. 1, PPP-based PPE 200 of FIG. 2, RTK positioning scheme 300 of FIG. 3, target GNSS device 520 of FIG. 5, and the like. In some examples, GNSS device 700 can perform one or more operations associated with the method 600 of FIG. 6. It should be noted that FIG. 7 is meant only to provide a generalized illustration of various components, any or all of which may be utilized as appropriate.

The GNSS device 700 is shown comprising hardware elements that can be electrically coupled via a bus 705 (or may otherwise be in communication, as appropriate). The hardware elements may include a processor(s) 710, which can include without limitation one or more general-purpose processors (e.g., an application processor), one or more special-purpose processors (such as digital signal processor (DSP) chips, graphics acceleration processors, application specific integrated circuits (ASICs), and/or the like), and/or other processing structures or means. Processor(s) 710 may comprise one or more processing units, which may be housed in a single integrated circuit (IC) or multiple ICs. As shown in FIG. 7, some embodiments may have a separate DSP 720, depending on desired functionality. Location determination and/or other determinations based on wireless communication may be provided in the processor(s) 710 and/or wireless communication interface 730 (discussed below). The GNSS device 700 also can include one or more input devices 770, which can include without limitation one or more keyboards, touch screens, touch pads, microphones, buttons, dials, switches, and/or the like; and one or more output devices 715, which can include without limitation one or more displays (e.g., touch screens), light emitting diodes (LEDs), speakers, and/or the like.

The GNSS device 700 may also include a wireless communication interface 730, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX device, a WAN device, and/or various cellular devices, etc.), and/or the like, which may enable the GNSS device 700 to communicate with other devices as described in the embodiments above. The wireless communication interface 730 may permit data and signaling to be communicated (e.g., transmitted and received) with TRPs of a network, for example, via eNBs, gNBs, ng-eNBs, access points, various base stations and/or other access node types, and/or other network components, computer systems, and/or any other electronic devices communicatively coupled with TRPs, as described herein. The communication can be carried out via one or more wireless communication antenna(s) 732 that send and/or receive wireless signals 734. According to some embodiments, the wireless communication antenna(s) 732 may comprise a plurality of discrete antennas, antenna arrays, or any combination thereof. The antenna(s) 732 may be capable of transmitting and receiving wireless signals using beams (e.g., Tx beams and Rx beams). Beam formation may be performed using digital and/or analog beam formation techniques, with respective digital and/or analog circuitry. The wireless communication interface 730 may include such circuitry.

Depending on desired functionality, the wireless communication interface 730 may comprise a separate receiver and transmitter, or any combination of transceivers, transmitters, and/or receivers to communicate with base stations (e.g., ng-eNBs and gNBs) and other terrestrial transceivers, such as wireless devices and access points. The GNSS device 700 may communicate with different data networks that may comprise various network types. For example, a WWAN may be a CDMA network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a WiMAX (IEEE 802.16) network, and so on. A CDMA network may implement one or more RATs such as CDMA2000®, WCDMA, and so on. CDMA2000® includes IS-95, IS-2000 and/or IS-856 standards. A TDMA network may implement GSM, Digital Advanced Mobile Phone System (D-AMPS), or some other RAT. An OFDMA network may employ LTE, LTE Advanced, 5G NR, and so on. 5G NR, LTE, LTE Advanced, GSM, and WCDMA are described in documents from 3GPP. CDMA2000® is described in documents from a consortium named “3rd Generation Partnership Project 2” (3GPP2). 3GPP and 3GPP2 documents are publicly available. A wireless local area network (WLAN) may also be an IEEE 802.11x network, and a wireless personal area network (WPAN) may be a Bluetooth network, an IEEE 802.15x, or some other type of network. The techniques described herein may also be used for any combination of WWAN, WLAN and/or WPAN.

The GNSS device 700 can further include sensor(s) 740. Sensor(s) 740 may comprise, without limitation, one or more inertial sensors and/or other sensors (e.g., accelerometer(s), gyroscope(s), camera(s), magnetometer(s), altimeter(s), microphone(s), proximity sensor(s), light sensor(s), barometer(s), and the like), some of which may be used to obtain position-related measurements and/or other information.

Embodiments of the GNSS device 700 may also include a Global Navigation Satellite System (GNSS) receiver 780 capable of receiving signals 784 from one or more GNSS satellites using an antenna 782 (which could be the same as antenna 732). Positioning based on GNSS signal measurement can be utilized to complement and/or incorporate the techniques described herein. The GNSS receiver 780 can extract a position of the GNSS device 700, using conventional techniques, from GNSS satellites of a GNSS system, such as Global Positioning System (GPS), Galileo, GLONASS, Quasi-Zenith Satellite System (QZSS) over Japan, IRNSS over India, BeiDou Navigation Satellite System (BDS), and/or the like. Moreover, the GNSS receiver 780 can be used with various augmentation systems (e.g., a Satellite Based Augmentation System (SBAS)) that may be associated with or otherwise enabled for use with one or more global and/or regional navigation satellite systems, such as, e.g., Wide Area Augmentation System (WAAS), European Geostationary Navigation Overlay Service (EGNOS), Multi-functional Satellite Augmentation System (MSAS), and Geo Augmented Navigation system (GAGAN), and/or the like.

It can be noted that, although GNSS receiver 780 is illustrated in FIG. 7 as a distinct component, embodiments are not so limited. As used herein, the term “GNSS receiver” may comprise hardware and/or software components configured to obtain GNSS measurements (measurements from GNSS satellites). In some embodiments, therefore, the GNSS receiver may comprise a measurement engine executed (as software) by one or more processors, such as processor(s) 710, DSP 720, and/or a processor within the wireless communication interface 730 (e.g., in a modem). A GNSS receiver may optionally also include a positioning engine, which can use GNSS measurements from the measurement engine to determine a position of the GNSS receiver using an Extended Kalman Filter (EKF), Weighted Least Squares (WLS), particle filter, or the like. The positioning engine may also be executed by one or more processors, such as processor(s) 710 or DSP 720.

The GNSS device 700 may further include and/or be in communication with a memory 760. The memory 760 can include, without limitation, local and/or network-accessible storage, a disk drive, a drive array, an optical storage device, a solid-state storage device, such as random-access memory (RAM), and/or a read-only memory (ROM), which can be programmable, flash-updateable, and/or the like. Such storage devices may be configured to implement any appropriate data stores, including, without limitation, various file systems, database structures, and/or the like.

The memory 760 of the GNSS device 700 also can comprise software elements (not shown in FIG. 7), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 760 that are executable by the GNSS device 700 (and/or processor(s) 710 or DSP 720 within GNSS device 700). In some embodiments, such code and/or instructions can be used to configure and/or adapt a general-purpose computer (or other device) to perform one or more operations in accordance with the described methods.

It will be apparent to those skilled in the art that substantial variations may be made in accordance with specific requirements. For example, customized hardware might also be used and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The terms “machine-readable medium” and “computer-readable medium” used herein refer to any storage medium that participates in providing data that causes a machine to operate in a specific fashion. In embodiments provided hereinabove, various machine-readable media might be involved in providing instructions/code to processors and/or other device(s) for execution. Additionally or alternatively, the machine-readable media might be used to store and/or carry such instructions/code. In many implementations, a computer-readable medium is a physical and/or tangible storage medium. Such a medium may take many forms, including, but not limited to, non-volatile media and volatile media. Common forms of computer-readable media include for example, magnetic and/or optical media, any other physical medium with patterns of holes, a RAM, a programmable ROM (PROM), erasable PROM (EPROM), a FLASH-EPROM, any other memory chip or cartridge, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus, many of the elements are examples that do not limit the scope of the disclosure to those specific examples.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussion, utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this specification, therefore, a special-purpose computer or a similar special-purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Terms “and” and “or” as used herein may include a variety of meanings that also are expected to depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more,” as used herein may be used to describe any feature, structure, or characteristic in the singular or may be used to describe some combination of features, structures, or characteristics. However, it should be noted that this is merely an illustrative example and that the claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

Having described several embodiments, various modifications, alternative constructions, and equivalents may be used without departing from the scope of the disclosure. For example, the above elements may merely be a component of a larger system, wherein other rules may take precedence over or otherwise modify the application of the various embodiments. Also, a number of steps may be undertaken before, during, or after the above elements are considered. Accordingly, the above description does not limit the scope of the disclosure.

In view of this description, embodiments may include different combinations of features. Implementation examples are described in the following numbered clauses:

Clause 1. An example method for Global Navigation Satellite System (GNSS)-based positioning performed by a GNSS device, the method may include receiving, from at least one satellite, a plurality of signals across a series of consecutive epochs and determining delta-ionosphere errors for the series of consecutive epochs, wherein each delta-ionosphere error indicates a change in ionospheric delay in carrier phase measurements taken on at consecutive epochs. The method may also include determining an ionosphere delay correction based on accumulating the delta-ionosphere errors and obtaining a position of the GNSS device based on the determined ionosphere delay correction.

Clause 2. The method of clause 1, wherein the position of the GNSS device is determined based on State-Space Representation (SSR) correction data and the determined ionosphere delay correction.

Clause 3. The method of clause 1 or 2, wherein the position of the GNSS device is determined using Precise Positioning Engine.

Clause 4. The method of any of clauses 1-3, wherein the at least one satellite comprises a dual-band satellite or a multi-band satellite, and wherein the plurality of signals comprise signals transmitted on at least two carrier frequencies.

Clause 5. The method of any of clauses 1-4, wherein determining the delta-ionosphere errors further comprises: determining an ionosphere-free combination of the carrier phase measurements from the signals transmitted on the at least two carrier frequencies.

Clause 6. The method of any of clauses 1-5, wherein the at least one satellite comprises a single-band satellite and wherein determining the delta-ionosphere error further comprises: obtaining a geometry-clock differential indicating a difference in combined geometry range and receiver clock offset between the consecutive epochs; and determining the delta-ionosphere error using the geometry-clock differential.

Clause 7. The method of any clauses 1-6, wherein the geometry-clock differential is obtained from a dual-band satellite, a multi-band satellite, an Inertial Measurement Unit (IMU) associated with the GNSS device, or any combination thereof.

Clause 8. The method of any of clauses 1-7, wherein determining the position of the GNSS device is further based on correcting a pseudo-range ionosphere error.

Clause 9. The method of any of clauses 1-9, wherein correcting the pseudo-range ionosphere error is performed using a Satellite-Based Augmentation System ionosphere model.

Clause 10. An example Global Navigation Satellite System (GNSS) device for GNSS-based positioning may comprise one or more transceivers, one or more memories, and one or more processors communicatively coupled with the one or more transceivers and the one or more memories. The one or more processors may be configured to receive, from at least one satellite, a plurality of signals across a series of consecutive epochs and determine delta-ionosphere errors for the series of consecutive epochs, wherein each delta-ionosphere error indicates a change in ionospheric delay in carrier phase measurements taken on at consecutive epochs. The one or more processors may also be configured to determine an ionosphere delay correction based on accumulating the delta-ionosphere errors and obtain a position of the GNSS device based on the determined ionosphere delay correction.

Clause 11. The GNSS device of clause 10, wherein the position of the GNSS device is determined based on State-Space Representation (SSR) correction data and the determined ionosphere delay correction.

Clause 12. The GNSS device of clause 10 or 11, wherein the position of the GNSS device is determined using Precise Positioning Engine.

Clause 13. The GNSS device of any of clauses 10-12, wherein the at least one satellite comprises a dual-band satellite or a multi-band satellite, and wherein the plurality of signals comprise signals transmitted on at least two carrier frequencies.

Clause 14. The GNSS device of any of clauses 10-13, wherein to determine the delta-ionosphere errors, the one or more processors is further configured to: determine an ionosphere-free combination of the carrier phase measurements from the signals transmitted on the at least two carrier frequencies.

Clause 15. The GNSS device of any of clauses 10-14, wherein the at least one satellite comprises a single-band satellite, and wherein to determine the delta-ionosphere errors, the one or more processors is further configured to: obtain a geometry-clock differential indicating a difference in combined geometry range and receiver clock offset between the consecutive epochs; and determine the delta-ionosphere error using the geometry-clock differential.

Clause 16. The GNSS device of any of clauses 10-15, wherein the geometry-clock differential is obtained from a dual-band satellite, a multi-band satellite, an Inertial Measurement Unit (IMU) associated with the GNSS device, or any combination thereof.

Clause 17. The GNSS device of any of clauses 10-16, wherein determining the position of the GNSS device is further based on correcting a pseudo-range ionosphere error.

Clause 18. The GNSS device of any of clauses 10-17, wherein correcting the pseudo-range ionosphere error is performed using a Satellite-Based Augmentation System ionosphere model.

Clause 19. An example apparatus for Global Navigation Satellite System (GNSS)-based positioning, the method may include means for determining delta-ionosphere errors for the series of consecutive epochs, wherein each delta-ionosphere error indicates a change in ionospheric delay in carrier phase measurements taken on at consecutive epochs and means for means for determining delta-ionosphere errors for the series of consecutive epochs, wherein each delta-ionosphere error indicates a change in ionospheric delay in carrier phase measurements taken on at consecutive epochs. The apparatus may also include means for means for determining an ionosphere delay correction based on accumulating the delta-ionosphere errors and means for obtaining a position of the apparatus based on the determined ionosphere delay correction.

Clause 20. The apparatus of claim 19, wherein the position of the apparatus is determined based on State-Space Representation (SSR) correction data and the determined ionosphere delay correction.

What is claimed is:

1. A method for Global Navigation Satellite System (GNSS)-based positioning performed by a GNSS device, the method comprising:
receiving, from at least one satellite, a plurality of signals across a series of consecutive epochs;
determining delta-ionosphere errors for the series of consecutive epochs, wherein each delta-ionosphere error indicates a change in ionospheric delay in carrier phase measurements taken on at consecutive epochs;
determining an ionosphere delay correction based on accumulating the delta-ionosphere errors; and
obtaining a position of the GNSS device based on the determined ionosphere delay correction.

2. The method of claim 1, wherein the position of the GNSS device is determined based on State-Space Representation (SSR) correction data and the determined ionosphere delay correction.

3. The method of claim 2, wherein the position of the GNSS device is determined using Precise Positioning Engine.

4. The method of claim 1, wherein the at least one satellite comprises a dual-band satellite or a multi-band satellite, and wherein the plurality of signals comprise signals transmitted on at least two carrier frequencies.

5. The method of claim 4, wherein determining the delta-ionosphere errors further comprises:
determining an ionosphere-free combination of the carrier phase measurements from the signals transmitted on the at least two carrier frequencies.

6. The method of claim 1, wherein the at least one satellite comprises a single-band satellite and wherein determining the delta-ionosphere error further comprises:
obtaining a geometry-clock differential indicating a difference in combined geometry range and receiver clock offset between the consecutive epochs; and
determining the delta-ionosphere error using the geometry-clock differential.

7. The method of claim 6, wherein the geometry-clock differential is obtained from a dual-band satellite, a multi-band satellite, an Inertial Measurement Unit (IMU) associated with the GNSS device, or any combination thereof.

8. The method of claim 1, wherein determining the position of the GNSS device is further based on correcting a pseudo-range ionosphere error.

9. The method of claim 8, wherein correcting the pseudo-range ionosphere error is performed using a Satellite-Based Augmentation System ionosphere model.

10. A Global Navigation Satellite System (GNSS) device for GNSS-based positioning, comprising:
one or more transceivers;
one or more memories; and
one or more processors communicatively coupled with the one or more transceivers and the one or more memories, wherein the one or more processors are configured to:
receive, from at least one satellite, a plurality of signals across a series of consecutive epochs;
determine delta-ionosphere errors for the series of consecutive epochs, wherein each delta-ionosphere error indicates a change in ionospheric delay in carrier phase measurements taken on at consecutive epochs;
determine an ionosphere delay correction based on accumulating the delta-ionosphere errors; and
obtain a position of the GNSS device based on the determined ionosphere delay correction.

11. The GNSS device of claim 10, wherein the position of the GNSS device is determined based on State-Space Representation (SSR) correction data and the determined ionosphere delay correction.

12. The GNSS device of claim 11, wherein the position of the GNSS device is determined using Precise Positioning Engine.

13. The GNSS device of claim 10, wherein the at least one satellite comprises a dual-band satellite or a multi-band satellite, and wherein the plurality of signals comprise signals transmitted on at least two carrier frequencies.

14. The GNSS device of claim 13, wherein to determine the delta-ionosphere errors, the one or more processors is further configured to:
determine an ionosphere-free combination of the carrier phase measurements from the signals transmitted on the at least two carrier frequencies.

15. The GNSS device of claim 10, wherein the at least one satellite comprises a single-band satellite, and wherein to determine the delta-ionosphere errors, the one or more processors is further configured to:
obtain a geometry-clock differential indicating a difference in combined geometry range and receiver clock offset between the consecutive epochs; and
determine the delta-ionosphere error using the geometry-clock differential.

16. The GNSS device of claim 15, wherein the geometry-clock differential is obtained from a dual-band satellite, a multi-band satellite, an Inertial Measurement Unit (IMU) associated with the GNSS device, or any combination thereof.

17. The GNSS device of claim 10, wherein determining the position of the GNSS device is further based on correcting a pseudo-range ionosphere error.

18. The GNSS device of claim 17, wherein correcting the pseudo-range ionosphere error is performed using a Satellite-Based Augmentation System ionosphere model.

19. An apparatus for Global Navigation Satellite System (GNSS)-based positioning, the apparatus comprising:
means for receiving, from at least one satellite, a plurality of signals across a series of consecutive epochs;
means for determining delta-ionosphere errors for the series of consecutive epochs, wherein each delta-ionosphere error indicates a change in ionospheric delay in carrier phase measurements taken on at consecutive epochs;
means for determining an ionosphere delay correction based on accumulating the delta-ionosphere errors; and
means for obtaining a position of the apparatus based on the determined ionosphere delay correction.

20. The apparatus of claim 19, wherein the position of the apparatus is determined based on State-Space Representation (SSR) correction data and the determined ionosphere delay correction.
